(19) United States
(12) Patent Application Publication
(10) Pub. No.: US 2017/0235464 A1
(43) Pub. Date: Aug. 17, 2017

(54) Computerized Search System Providing Nested Application Card Results

(71) Applicant: Quixey, Inc., Mountain View, CA (US)

(72) Inventor: Jonathan BEN-TZUR, Sunnyvale, CA (US)

(21) Appl. No.: 15/397,598

(22) Filed: Jan. 3, 2017

Related U.S. Application Data
(63) Continuation-in-part of application No. 14/970,504, filed on Dec. 15, 2015.
Application No. 14/970,504 is a continuation-in-part of application No. 14/968,831, filed on Dec. 14, 2015.
(60) Provisional application No. 62/274,061, filed on Dec. 31, 2015.

(51) Int. Cl. G06F 3/0484; G06F 17/30

(52) U.S. Cl. CPC G06F 3/04845; G06F 17/30867; G06F 17/30991

(57) ABSTRACT

A search server includes a storage device that stores card records. Each of the card records includes information associated with a respective application card to be provided in response to search queries. The search server includes a network communication device that receives a card request from a mobile computing device. The card request includes a search query. The search server includes a processing device that, based on the search query, selects a first card record from the stored card records. The processing device generates a first application card using the information included in the first card record. The processing device identifies a second card record based on information included in the first application card. The processing device selectively generates a second application card using information included in the second card record. The network communication device transmits the first application card and the second application card to the mobile computing device.

### CROSS-REFERENCE TO RELATED APPLICATIONS

This application claims the benefit of U.S. Provisional Application No. 62/274,061, filed on Dec. 31, 2015. This application is a continuation-in-part of U.S. application Ser. No. 14/968,831, filed Dec. 14, 2015 and a continuation-in-part of U.S. application Ser. No. 14/970,504, filed Dec. 15, 2015. The entire disclosures of the applications referenced above are incorporated by reference.

### FIELD

This disclosure relates to search systems for mobile computing devices and more particularly to search systems configured to return search results in application card format.

### BACKGROUND

Many mobile computing devices can display a graphical user interface that allows a user of the mobile computing device to enter a search query. Upon receiving the search query from the user, the mobile computing device can transmit the search query to a search server. The search server can generate search results based on the search query. Upon generating the search results, the search server can send the search results to the mobile computing device. The mobile computing device receives the search results, and can display the search results on a display of the mobile computing device. Some mobile computing devices can display the search results in the form of a card.

A card, also called a deep view card (DVC), for an application or a state of an application shows additional information beyond just the identification of the application or application state. For example, the information may include a title of the application state or a description of the application state, which may be a snippet of text from the application state. Other metadata may be provided from the application state, including images, location, number of reviews, average review, and status indicators. For example, a status indicator of “open now” or “closed” may be applied to a business depending on whether the current time is within the operating hours of the business.

Some DVCs may emphasize information that led to the DVC being selected as a search result. For example, text within the DVC that matches a user's query may be shown in bold or italics. The DVC may also incorporate elements that allow direct actions, such as the ability to immediately call an establishment or to transition directly to a mapping application to get navigation directions to the establishment.

Other interactions with the DVC (such as tapping or clicking any other area of the DVC) may take the user to the indicated state or application. As described in more detail below, this may be accomplished by opening the relevant application or, if the application is not installed, opening a website related to the desired application state. In other implementations, an application that is not installed may be downloaded, installed, and then executed in order to reach the desired application state.

In other words, a DVC includes identifying information for the application or state as well as additional content from the application or state itself. The additional content allows the user to make a more informed choice about which result to choose, and may even allow the user to directly perform an action without having to navigate to the application state. If the action the user wants to take is to obtain information, in some circumstances the DVC itself may provide the necessary information to accomplish such action.

### SUMMARY

A search server includes a storage device that stores a plurality of card records. Each of the card records includes information associated with a respective application card to be provided in response to search queries. The search server includes a network communication device that receives a card request from a mobile computing device. The card request includes a search query. The search server includes a processing device that, based on the search query, selects a first card record from the stored plurality of card records. The processing device generates a first application card using the information included in the first card record. The processing device identifies a second card record based on information included in the first application card. The processing device selectively generates a second application card using information included in the second card record. The network communication device transmits the first application card and the second application card to the mobile computing device.

In other features, to select the first card record, the processing device generates a consideration set of card records based on the search query included in the card request, assigns scores to the card records in the consideration set, and selects the first card record based on the assigned scores. In other features, to identify the second card record, the processing device (i) identifies, in the information included in the first application card, a value associated with the second card record and (ii) identifies the second card record based on the identified value.

In other features, the information included in each of the card records includes a card record identifier, a data field indicating a display priority associated with the card record, physical dimensions associated with the card record, and information about an access mechanism associated with the card record. In other features, the card request includes characteristics of a display screen of the mobile computing device. In other features, the characteristics include at least one of a screen size of the display screen and a screen orientation of the display screen.

In other features, to generate the second application card, the processing device (i) determines an amount of display space available based on the characteristics of the display screen, (ii) determines at least one of a display priority and physical dimensions associated with the second card record, and (iii) selectively generates the second application card based on the determined amount of display space and the determined at least one of the display priority and the physical dimensions associated with the second card record.

In other features, the characteristics include a screen size of the display screen. To generate the second application card, the processing device determines an amount of display space available for the second application card based on the screen size. The processing device, for each data field of the second card record, identifies a respective priority and a respective display size. The processing device identifies the data field of the second card record having a highest priority value. The processing device, in response to the respective display size of the identified data field being less than the amount of display space available, adds the identified data field to the second application card. The processing device, in response to the respective display size of the identified data field being greater than the amount of display space available, adds one of the data fields having a lower priority value to the second application card. The respective display size of the one of the data fields is less than the amount of display space available. In other features, to generate the second application card, the processing device nests the second application card within the first application card.

A method of operating a search system provides application cards in response to search queries. The method includes storing a plurality of card records. Each of the card records includes information associated with the application cards. The method includes receiving a card request from a mobile computing device. The card request includes a search query. The method includes, based on the search query, selecting a first card record from the stored plurality of card records. The method includes generating a first application card using the information included in the first card record. The method includes identifying a second card record based on information included in the first application card. The method includes selectively generating a second application card using information included in the second card record. The method includes transmitting the first application card and the second application card to the mobile computing device.

In other features, selecting the first card record includes generating a consideration set of card records based on the search query included in the card request, assigning scores to the card records in the consideration set, and selecting the first card record based on the assigned scores. In other features, identifying the second card record includes (i) identifying, in the information included in the first application card, a value associated with the second card record and (ii) identifying the second card record based on the identified value.

In other features, the information included in each of the card records includes a card record identifier, a data field indicating a display priority associated with the card record, physical dimensions associated with the card record, and information about an access mechanism associated with the card record. In other features, the card request includes characteristics of a display screen of the mobile computing device. In other features, the characteristics include at least one of a screen size of the display screen and a screen orientation of the display screen.

In other features, generating the second application card includes (i) determining an amount of display space available based on the characteristics of the display screen, (ii) determining at least one of a display priority and physical dimensions associated with the second card record, and (iii) selectively generating the second application card based on the determined amount of display space and the determined at least one of the display priority and the physical dimensions associated with the second card record.

In other features, the characteristics include a screen size of the display screen. Generating the second application card includes determining an amount of display space available for the second application card based on the screen size and, for each data field of the second card record, identifying a respective priority and a respective display size. Generating the second application card further includes identifying the data field of the second card record having a highest priority value and, in response to the respective display size of the identified data field being less than the amount of display space available, adding the identified data field to the second application card. Generating the second application card further includes, in response to the respective display size of the identified data field being greater than the amount of display space available, adding one of the data fields having a lower priority value to the second application card. The respective display size of the one of the data fields is less than the amount of display space available. In other features, generating the second application card includes nesting the second application card within the first application card.

A non-transitory computer-readable medium stores instructions for execution on processing hardware. The instructions include storing, at a storage device, a card data store that stores card records. Each card record includes a card record identifier (ID), one or more data fields, and an access mechanism template. Each data field is associated with a display priority and a physical dimension. The instructions include receiving, via a network communication device, a card request from a mobile computing device. The card request includes a search query with one or more search terms and a screen size/orientation of the mobile computing device. The instructions include generating a consideration set of card records based on the search terms in the query. The instructions include scoring the card records in the consideration set. The instructions include selecting one or more card records from the consideration set based on the scores of the card records. The instructions include generating a parent card object for each of the selected card records. The instructions include, for each parent card object, identifying at least one value in one of the data fields that is associated with another card record. The instructions include generating a child card object based on the other card record. The instructions include determining an amount of display space that is available for rendering a child application card. The instructions include writing data fields from the other card record into the child card object based on the display priorities associated with the data fields and a comparison of the physical dimensions of the data fields with the screen size, and/or screen orientation. The instructions include transmitting, via the network communication device, the parent card object and the child card object to the mobile computing device.

In other features, the card request includes a screen size of the display screen of the mobile computing device. Generating the child card object includes determining an amount of display space available for the child card object based on the screen size and, for each of the data fields of the other card record, identifying a respective priority and a respective display size. Generating the child card object includes identifying the data field of the other card record having a highest priority value and, in response to the respective display size of the identified data field being less than the amount of display space available, adding the identified data field to the child card object. Generating the child card object includes in response to the respective display size of the identified data field being greater than the amount of display space available, adding one of the data fields having a lower priority value to the child card object. The respective display size of the one of the data fields is less than the amount of display space available.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

FIG. 1 is a schematic diagram of a system that provides nested application cards.

FIG. 2 is a block diagram of a card server that generates nested application cards.

FIG. 3 is a diagram of a method that the card server may execute to generate the nested application card(s).

FIG. 4 is a diagram of a method that the mobile computing device may execute to render the nested application card(s).

Like reference symbols in the various drawings indicate like elements.

### DETAILED DESCRIPTION

The present disclosure provides a system that may be used to render nested application cards. A nested application card may refer to an application card that is displayed within another application card. A mobile computing device may display various application cards. For example, the mobile computing device may display the application cards as search results in response to receiving a search query. Some of the application cards may include sponsored content. Application cards that display sponsored content may be referred to as advertisement cards. An application card may represent an application function of an application. The application may include a native application that is installed or can be installed at the mobile computing device. Alternatively, the application may include a web application that is hosted by a web server, and that the mobile computing device may access via a web browser.

An application card that includes a nested application card may be referred to as a parent card. Moreover, an application card that is nested within another application card may be referred to as a child card. Furthermore, an application card that is nested within a child card may be referred to as a grandchild card. The mobile computing device may display application cards with additional levels of nesting. For example, the grandchild card may include another nested application card (which may be referred to as a great-grandchild card). A user of the mobile computing device may indicate the number of nesting levels. Alternatively or additionally, the mobile computing device and/or a card server that provides the application cards may determine the number of nesting levels.

An application card may include various data fields that display information from an application state that corresponds to the application card. For example, an application card may include a title field that displays a title (e.g., a name), an image field that displays an image, a description field, a reviews field, etc. In some implementations, a data field of an application card may include a value that refers to another application state. In such implementations, the application card may include a nested application card that displays information regarding the other application state. For example, a parent card may display information regarding a movie. The parent card may include a data field that displays names of actors that were casted in that movie. In this example, the parent card may include child cards for each actor. A child card for an actor can display information regarding the actor. The mobile computing device may display a child card upon detecting a user selection of a value that corresponds to the child card. For example, the mobile computing device may display a child card for an actor upon detecting a user selection of the name of the actor within the parent card for the movie.

A nested application card may include one or more data fields. The look-and-feel for the nested application card may vary based on the display area available for the nested application card. Specifically, the number of data fields, and/or the sizes of the data fields may vary based on the display area that is available for the nested application card. The display area for the nested application card may be determined by the mobile computing device, and/or the card server that generates the nested application card. For example, the display area for the nested application card may be limited to a threshold percentage of the parent card (e.g., 30%).

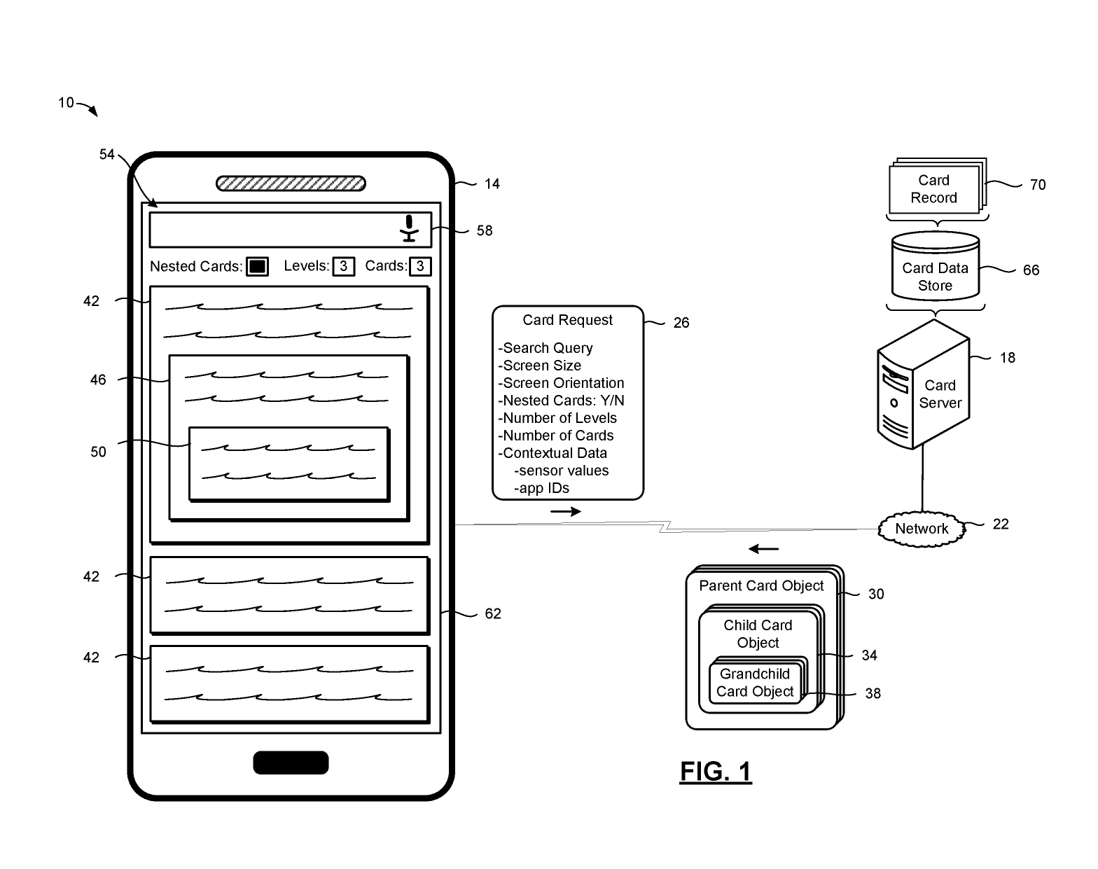

FIG. 1 illustrates a schematic diagram for a system 10 that renders nested application cards. The system 10 includes a mobile computing device 14, and a card server 18. The mobile computing device 14 and the card server 18 may communicate via a network 22. In operation, the mobile computing device 14 generates a card request 26, and transmits the card request 26 to the card server 18. The card server 18 receives the card request 26 from the mobile computing device 14. Upon receiving the card request 26, the card server 18 sends one or more parent card objects 30 to the mobile computing device 14. A parent card object 30 may include one or more child card objects 34. Furthermore, a child card object 34 may include one or more grandchild card objects 38. As illustrated, one or more child card objects 34 may be nested (e.g., included) within a parent card object 30. Similarly, one or more grandchild card objects 38 may be nested within a child card object 34.

The mobile computing device 14 receives the one or more parent card objects 30 from the card server 18. The mobile computing device 14 utilizes a parent card object 30 to display a parent card 42. The mobile computing device 14 can utilize a child card object 34 to display a child card 46 that is nested within the parent card 42. Furthermore, the mobile computing device 14 can utilize a grandchild card object 38 to display a grandchild card 50 that is nested within the child card 46. The mobile computing device 14 may automatically display a child card 46 within a parent card 42. Alternatively, the mobile computing device 14 may display the child card 46 upon detecting a user input to display the child card 46. For example, one of the data fields of the parent card 42 may include a value that corresponds to a particular application state. In this example, the mobile computing device 14 may display the child card 46 upon detecting a user selection of the value. The child card 46 may include information from that particular application state.

The mobile computing device 14 includes a graphical user interface (GUI) 54. The GUI 54 may include a search box 58 that can accept a search query from a user of the mobile computing device 14. The GUI 54 may include a nested cards option. The user may select the nested cards option to allow (e.g., enable) the mobile computing device 14 to render nested application cards. The user can also specify a maximum number of nested levels that the application cards may include. For example, if the user specifies “3” as the maximum number of nested levels, then the mobile computing device 14 may display a parent card 42, a child card 46, and a grandchild card 50, but not a great-grandchild card. The user may also specify a maximum number of cards that the mobile computing device 14 may display.

The mobile computing device 14 may generate the card request 26. The mobile computing device 14 may generate the card request 26 upon detecting that the user has entered a search query in the search box 58. The card request 26 may include the search query. The card request 26 may indicate a screen size, a screen orientation, a current value of the nested cards option, the maximum number of nested levels, the maximum number of cards, and/or contextual data. The screen size may refer to the physical dimensions of a display 62 of the mobile computing device 14. The screen size may include a display resolution of the display 62. In some implementations, the card request 26 may indicate the screen size by including the make and model of the mobile computing device 14.

The screen orientation may include the current display orientation of the mobile computing device 14 (e.g., portrait, or landscape). The current value of the nested cards option may include a Boolean value. A “1” may indicate that the mobile computing device 14 is allowed to display nested application cards. A “0” may indicate that the mobile computing device 14 is not allowed to display nested application cards. The maximum number of nested levels may include an integer that the user may have provided. The maximum number of cards may include an integer that the user may have provided. The contextual data may include sensor measurements values (e.g., a location of the mobile computing device 14), application data (e.g., application IDs for the native applications installed at the mobile computing device 14), etc.

The card server 18 may include a card data store 66 that stores various card records. A card record 70 may correspond to a particular state of a particular application. In other words, a card record 70 may correspond to a particular application state. A card record 70 may correspond to a particular functionality of an application. In other words, a card record 70 may correspond to a particular application function. The card server 18 selects one or more card records 70 that may be relevant to the search query. Upon selecting the card records 70 that are relevant to the search query, the card server 18 utilizes the card records 70 to generate the parent card objects 30. If a selected card record 70 includes values that refer to other card records 70, then the card server 18 can utilize the other card records 70 to generate the child card objects 34.

The card server 18 determines the data fields to include in a nested card object (e.g., a child card object 34). The card record 70 that the card server 18 may utilize to generate the child card object 34 may include various data fields. However, there may not be enough display area available to render all the data fields. Hence, the card server 18 can select some of the data fields from the card record 70, and include the selected data fields in the child card object 34. The card server 18 may utilize various techniques to select the data fields to include in the child card object 34. For example, the data fields may be associated with priorities. In this example, the card server 18 may select data fields in ascending order of priority. In other words, the card server 18 may select data fields that are associated with the highest priority, and not select data fields that are associated with the lowest priority.

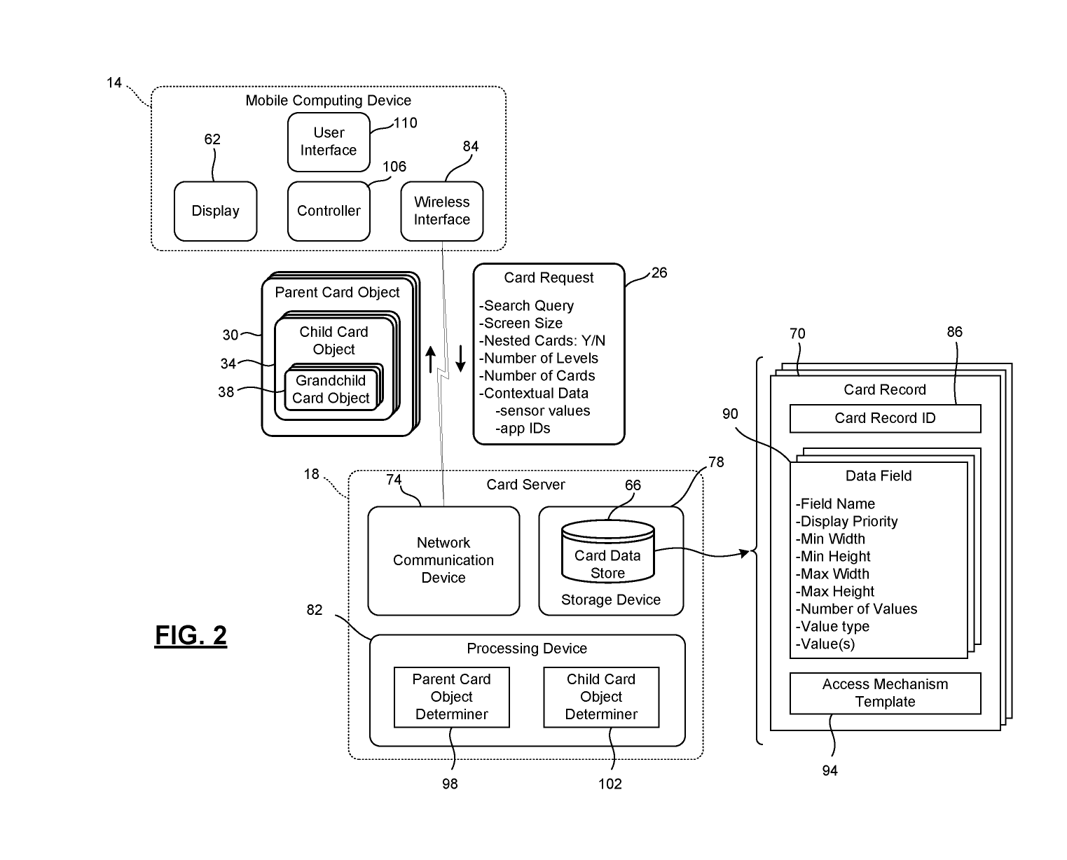

FIG. 2 illustrates an example block diagram for the card server 18. The card server 18 may include a network communication device 74, a storage device 78, and a processing device 82. The card server 18 may be implemented by a cloud computing platform (not shown). The cloud computing platform may include a collection of remote computing services. The cloud computing platform may include computing resources (e.g., the processing device 82). The computing resources may include physical servers that have physical central processing units (pCPUs). The cloud computing resources may include storage resources (e.g., the storage device 78). The storage resources may include database servers that support NoSQL, MySQL, Oracle, SQL Server, or the like. The cloud computing platform may include networking resources (e.g. the network communication device 74). Example cloud computing platforms include Amazon Web Services®, Google Cloud Platform®, Microsoft AZURE™ and Alibaba Aliyun™.

The network communication device 74 communicates with a network (e.g., the network 22 shown in FIG. 1). The network communication device 74 may implement a communication interface that performs wired communication (e.g., via Ethernet, Universal Serial Bus (USB) or fiber-optic cables). The network communication device 74 may perform wireless communication (e.g., via Wi-Fi, Bluetooth, Bluetooth Low Energy (BLE), Near Field Communications (NFC), ZigBee, a cellular network, or satellites). The network communication device 74 may include a transceiver (not shown). The transceiver may operate in accordance with an Institute of Electrical and Electronics Engineers (IEEE) specification (e.g., IEEE 802.3 or IEEE 802.11). The transceiver may operate in accordance with a 3rd Generation Partnership Project (3GPP) specification (e.g., Code Division Multiple Access (CDMA), Long Term Evolution (LTE), or LTE-Advanced). The transceiver may operate in accordance with a Universal Serial Bus (USB) specification (e.g., via a USB port). For example only, the network communication device 74 receives card requests 26 transmitted by a wireless interface 84 of the mobile computing device 14 and provides the parent card objects 30 in response to the card requests 26.

The storage device 78 stores data. The storage device 78 may include one or more computer readable storage mediums. For example, the storage device 78 may include solid state memory devices, hard disk memory devices, optical disk drives, read-only memory, and/or nanotube-based storage devices 78. The storage device 78 may be connected to the processing device 82 via a bus, and/or a network 22. Different storage mediums within the storage device 78 may be located at the same physical location (e.g., in the same data center, same rack, or same housing). Different storage mediums of the storage device 78 may be distributed (e.g., in different data centers, different racks, or different housings). The storage device 78 may store a card data store 66.

The card data store 66 stores card records 70. The card records 70 store information that can be utilized to display the application cards at the mobile computing device 14. A card record 70 may include a card record ID 86, one or more data fields 90, and/or an access mechanism template 94. The card record ID 86 may include a string that identifies the card record 70. A data field may include one or more values. In some scenarios, a value of a data field may be associated with another card record 70. A data field that stores a value that is associated with another card record 70 may be referred to as a reference field.

A data field may be associated with a field name, display priority, and/or physical dimensions (e.g., a minimum width, a minimum height, a maximum width, and/or a maximum height). A data field may indicate the number of values that the data field stores, and the type of values that the data field stores. The display priority may include an integer value that facilitates the card server 18 in determining whether to include the data field in a child card object 34. Specifically, the card server 18 may determine the amount of display space available for a child card 46. Upon determining the amount of space available for the child card 46, the card server 18 may select the highest priority data field(s) that fit within the available display space. In other words, when selecting the data fields that a nested card may display, the card server 18 gives priority to a higher priority data field over a lower priority data field. If a higher priority data field may not fit the available display space, then the card server 18 may select a lower priority data fit that may fit within the available display space.

The physical dimensions that are associated with a data field may have been determined by a developer of the application function that corresponds to the card record 70. In some implementations, a data field may be associated with a preferred screen size, and/or a preferred screen orientation. If the screen size of the mobile computing device 14 that sent the card request 26 matches the preferred screen size, then the card server 18 may include the data field in the nested application card. If the screen size of the mobile computing device 14 does not match the preferred screen size, then the card server 18 may not include the data field in the nested application card. Similarly, if a current screen orientation of the mobile computing device 14 matches the preferred screen orientation, then the card server 18 may include the data field in the nested application card. If the current screen orientation does not match the preferred screen orientation, then the card server 18 may not include the data field in the nested application card.

The access mechanism template 94 may include a template for an access mechanism. An access mechanism may refer to a string that identifies an application function, and provides access to the application function. An access mechanism may include a uniform resource identifier (URI), a uniform resource locator (URL), an application resource identifier (ARI), or the like. The card server 18 can parameterize (e.g., populate) the access mechanism template 94. The card server 18 can parameterize the access mechanism template 94 with the data fields that the card server 18 selected. The card server 18 can parameterize the access mechanism template 94 with the value(s) of the selected data field(s). In some implementations, the card object may include the access mechanism that the card server 18 generated by parameterizing the access mechanism template 94.

The card records 70 may correspond to application states of various applications. For example, the card records 70 may correspond to application states of native applications that can be installed at mobile computing devices 14. The card records 70 may correspond to application states of web applications (e.g., with webpages of a website). The data fields of a card record 70 may store information that the corresponding application state displays. For example, if a card record 70 corresponds to an application state that displays information about The Dark Knight movie, then the card record 70 may include data fields for the movie title, the release year, etc. In this example, the card record 70 may also data fields for the actors in the movie, the ratings for the movie, the reviews for the movie, etc.

The processing device 82 may implement a collection of one or more computing processors that execute computer readable instructions. The computing processors of the processing device 82 may operate independently or in a distributed manner. The computing processors may be connected via a bus (not shown) and/or a network 22. The computing processors may be located in the same physical device (e.g., same housing). The computing processors may be located in different physical devices (e.g., different housings, for example, in a distributed computing system). A computing processor may include physical central processing units (pCPUs). A pCPU may execute computer-readable instructions to implement virtual central processing units (vCPUs). The processing device 82 may execute computer-readable instructions that correspond to a parent card object determiner 98, and a child card object determiner 102.

The parent card object determiner 98 determines (e.g., generates) one or more parent cards 42. The number of parent cards 42 that the parent card object determiner 98 determines may equal the number of cards requested in the card request 26. The parent card object determiner 98 selects one or more card records 70 from the card data store 66 based on the search query. In some implementations, the card data store 66 may include a data structure (e.g., a mapping mechanism such as an inverted index, a look-up table, etc.) that maps keywords to the card record IDs 86. In such implementations, the parent card object determiner 98 can query the data structure with the search terms of the search query. In return, the parent card object determiner 98 can receive the card record ID(s) 86 for the card record(s) 70 that correspond to the search terms of the search query.

In some implementations, the parent card object determiner 98 may tokenize the search query prior to selecting the card records 70 from the card data store 66. Tokenizing the search query may refer to generating parsed tokens from the search terms of the search query. The parent card object determiner 98 can use a tokenizer to tokenize the search query. The tokenizer can use various techniques to generate the tokens. In some examples, the tokenizer generates the tokens by splitting the characters of the search query with a given delimiter (e.g., a space). The parent card object determiner 98 can perform various other operations to the search query prior to selecting the card records 70. For example, the card server 18 may perform stemming by reducing the words in the search query to their stem word, or root word. The parent card object determiner 98 can perform synonym ization by identifying synonyms of search terms in the search query. The card server 18 may also perform stop word removal by removing commonly occurring words from the search query (e.g., by removing “a”, “and”, etc.). The card server 18 can also identify misspelled words, and replace the misspelled words with the correct spelling. Some of the operations described herein may be referred to as ‘cleaning’ the search query.

In some implementations, the parent card object determiner 98 can score the selected card records 70. Scoring a selected card record 70 may refer to generating a relevance score for the selected card record 70. The relevance score for the selected card record 70 may indicate how relevant the selected card record 70 is to the search query. The parent card object determiner 98 can compute a set of scoring features for the selected card record 70, and determine a relevance score for the selected card record 70 based on the scoring features. The scoring features may include record scoring features, query scoring features, and/or record-query scoring features.

A record scoring feature may be associated with a card record 70. A record scoring feature may include data associated with an application state that corresponds to the card record 70. For example, a record scoring feature may include one or more values from the one or more data fields. A record scoring feature may include parameters related to the application state that corresponds to the card record 70. A record scoring feature may include data that indicates a popularity of the corresponding application state. For example, a record scoring feature may indicate a number of times that the card record 70 has been utilized to generate an application card at a mobile computing device 14. A record scoring feature may indicate a rating of the corresponding application state (e.g., a number of stars associated with the application state). A record scoring feature may include a Boolean value that indicates whether the card record 70 includes a data field that stores a value associated with another card record 70. In other words, the Boolean value may indicate whether an application card rendered based on the card record 70 can include a nested application card. A record scoring feature may include the number of nested application cards that the card record 70 can support. In other words, the record scoring feature may indicate the number of other card records 70 that are associated with the values of the data fields. A record scoring feature may include the number of nesting levels that the card record 70 can support.

A query scoring feature may be associated with the search query. A query scoring feature may include data associated with the search query. Example query scoring features may include a number of words in the search query, a popularity of the search query, and/or an expected frequency of the words in the search query. A record-query scoring feature may include data that may be generated based on data associated with the selected card record 70, and the search query. A record-query scoring feature may include parameters that indicate a number of matches between the terms of the search query and the selected card record 70.

The parent card object determiner 98 can score the card records 70 based on the scoring features. The parent card object determiner 98 may include a machine learned model(s) (e.g., a supervised learning model). The machine learned model may be configured to receive the scoring features, and score the card records 70 based the scoring features. Specifically, the parent card object determiner 98 may determine a feature vector that includes the record scoring feature(s), the query scoring feature(s), and/or the record-query scoring feature(s). The parent card object determiner 98 may use the feature vector as an input for a machine-learned regression model to calculate a score for the card record 70. The machine-learned regression model may include a set of decision trees (e.g., gradient boosted decision trees). The machine-learned regression model may include a logistic probability formula. A machine learned task may be implemented as a semi-supervised learning task, where a portion of the training data is labeled with human-curated scores, and the remaining training data may be used without human-curated scores.

The parent card object determiner 98 generates one or more parent card objects 30. A parent card object 30 includes information from the card records 70 selected by the parent card object determiner 98. For example, a parent card object 30 may include the values from the data fields in the selected card record 70, and/or the access mechanism. The parent card object determiner 98 can instantiate a data container that represents the parent card object 30. The data container may include a JSON (JavaScript Object Notation) object, an XML (Extensible Markup Language) file, etc. Upon instantiating the data container, the parent card object determiner 98 can write the values of the data fields, and/or the access mechanism to the data container.

The child card object determiner 102 determines (e.g., generates) child card objects 34. The parent card object determiner 98 may generate one or more child card objects 34 for each parent card object 30 generated by the parent card object determiner 98. The child card object 34 determiner may analyze a parent card object 30, and identify a value in a data field that is associated with another card record 70. In other words, the child card object determiner 102 may identify values for which a nested application card can be displayed. Upon identifying a card record 70 that can be utilized to display the nested application card, the child card object determiner 102 can determine which data fields to include in the nested application card.

The data fields that the child card object determiner 102 can include in a child card object 34 may be based on the amount of display space available for the child card 46. The child card object determiner 102 may determine the amount of display space that is available for the child card 46. In some implementations, the maximum amount of display space for the child card 46 may be a threshold percentage of the amount of space that the parent card 42 utilizes (e.g., 30%). The threshold percentage may have been specified by a developer of the application function with which the card records 70 correspond. In some implementations, the amount of display space for the child card 46 may be based on the number of nested levels, and/or the number of cards that are to be displayed. If the number of nested levels, or the number of cards that are to be displayed is relatively high, then the amount of display space for the child card 46 may be relatively less.

The child card object determiner 102 can determine which data fields to include in the child card object 34 based on the information associated with the data fields. In some implementations, the child card object determiner 102 may start by including the data field with the highest priority, and include other data fields in ascending order of priority until there is no display space remaining to include any other data fields. For example, the child card object determiner 102 may determine whether there is enough display space to include a first data field with a display priority of “1”. If the physical dimensions associated with the first data field indicate that the first data field may fit within the amount of display space available, then the child card object determiner 102 includes the first data field in the child card object 34. After including the first data field, the child card object determiner 102 can compute the amount of remaining display space. If the remaining display space can accommodate a second data field with a display priority of “2”, then the child card object determiner 102 includes the second data field in the child card object 34. If the physical dimensions of the second data field are larger than the remaining display space, then the child card object determiner 102 does not include the second data field in the child card object 34. The child card object determiner 102 may determine whether to include the third data field with a display priority of “3”.

In some implementations, the child card object determiner 102 may not skip more than a threshold number of contiguous (e.g., sequential) display priorities. In some examples, the threshold number may be three. In such examples, if the child card object determiner 102 does not include the data fields with display priorities of “3”, “4”, “5” and “6”, then the child card object determiner 102 may not include the data field with the display priority of “7”. In such examples, the child card object determiner 102 may not include the data field with the display priority of “7” even if the data field fits the amount of remaining display space because including that data field will result in skipping more than three sequential display priorities (e.g., “3”, “4”, “5” and “6”).

The child card object determiner 102 generates the child card object 34. Generating the child card object 34 may include writing information regarding the child card object 34 into a portion of the parent card object 30. The child card object determiner 102 may write the data fields that the child card object determiner 102 selected for the child card 46. The child card object determiner 102 may write the values for the data fields. In some implementations, generating the child card object 34 may include parameterizing the access mechanism template 94 stored in the card record 70 that the child card object determiner 102 is utilizing to generate the child card object 34. The child card object determiner 102 may parameterize that child card object 34 with the search terms of the search query. Parameterizing the access mechanism template 94 results in an access mechanism. The child card object determiner 102 can include that access mechanism in the child card object 34.

In some implementations, the parent card object 30 may include an access mechanism that the mobile computing device 14 can utilize to render the parent card 42. For example, the mobile computing device 14 may include a control module or controller 106 configured to generate the card requests 26 (e.g., responsive to a search query provided by a user at a user interface 110, which may include a touchscreen implemented by the display 62). The controller 106 implements other functions of the mobile computing device 14 including, but not limited to, processing the parent card objects 30, child card objects 34, and grandchild card objects 38 to be provided to the user via the display 62. The parent card object 30 may include one or more child card objects 34. A child card object 34 may also include an access mechanism that the mobile computing device 14 can utilize to render the child card 46 within the parent card 42. Hence, the parent card object 30 may be a parent access mechanism, and the child card object(s) 34 may be a child access mechanism that is nested under the parent access mechanism.

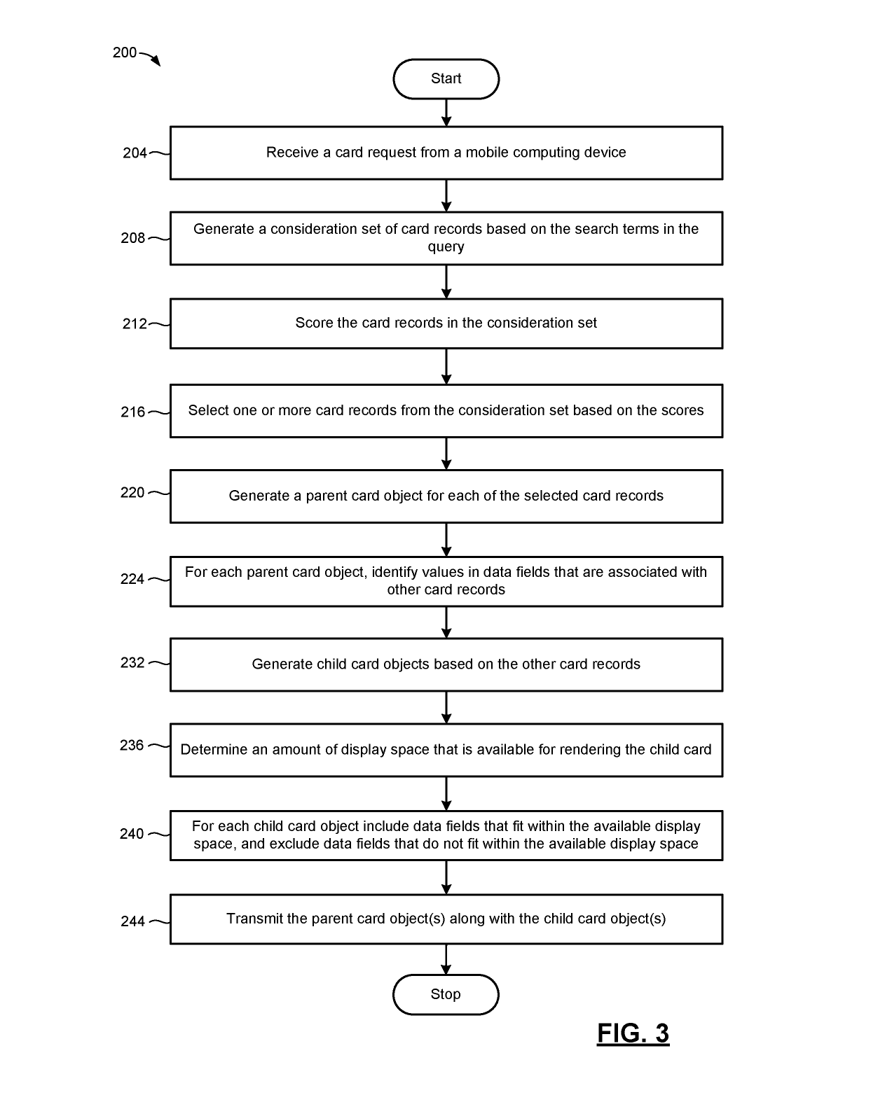

FIG. 3 illustrates a method 200 for rendering nested application cards. The method 200 can be implemented as a set of computer readable instructions that may be executed by a computing processor of a card server (e.g., the processing device of the card server 18 shown in FIG. 2). The card server 18 receives a card request from a mobile computing device at 204. The card request may include a search query with one or more search terms. The card request may include information regarding the mobile computing device. For example, the card request may include a screen size, a screen orientation, etc. The card request may include other information, as illustrated in FIGS. 1 and 2.

At 208, the card server generates a consideration set of card records based on the search terms in the search query. The card server may include a card data store, as illustrated in FIGS. 1 and 2. The card data store may include a mapping mechanism that maps keywords to card record IDs. The card server can query the mapping mechanism with the search terms of the search query, and receive a set of card record IDs that correspond to the search terms. The card server may perform certain operations that may be referred to as “cleaning” the search query (e.g., stemming, stop word removal, etc.).

At 212, the card server scores the card records in the consideration set. Scoring the card records may include computing a set of scoring features for the record, and utilizing a machine-learned model to generate a relevance score. The card server selects one or more card records from the consideration set based on the relevance scores at 216. The number of card records that the card server selects may be based on a number of cards requests in the card request. For example, if the card request requests three cards, then the card server may select a first card record with the highest score, a second card record with the second highest score, and a third card record with the third highest score.

At 220, the card server generates one or more parent card objects based on the selected card records. Specifically, the card server generates a parent card object for each of the selected card records. Generating the parent card object may include writing information from the selected card record into a data container that represents the parent card object. Some parent card objects may include a child card object. While the parent card object may be utilized by the mobile computing device to render a parent card, the child card object can be utilized by the mobile computing device to render a child card that is nested within the parent card.

At 224, for each parent card object, the card server may identify values that are associated with other card records. In other words, the card server may identify other card records that the selected card record refers to. The card server may utilize the other card records to generate child card objects. Put another way, the other card records may include information that can be utilized to render child cards at the mobile computing device. The card server generates child card objects based on the information included in the other card records at 228. Generating the child card objects may include determining which data fields to include in the child card object. For example, a card record may include ten data fields but the amount of display space available (e.g., allotted) for the child card may only accommodate three data fields. Hence, the card server may determine which of the three data fields to include in the child card object.

At 232, the card server determines the amount of display space (e.g., display area) that is available for the child card. At 236, the card server may determine the amount of display space based on the number of cards requested in the card request, the screen size, and/or the screen orientation. Upon determining the amount of display space that is available, at 240 the card server may include the data fields that fit within the display space, and exclude the data fields that do not fit within the display space. The data fields may be associated with physical dimensions, and the card server can utilize the physical dimensions to determine whether the data field may fit within a given display space. In determining which data fields to include, the card server can include data fields in ascending order of priority. In other words, data fields that are associated with a higher display priority are included before a data field with a lower display priority is considered for inclusion.

At 244, the card server transmits the parent card object(s) along with any child card object(s). The child card object(s) may be nested within their respective parent card object. Transmitting the parent card object may include transmitting an access mechanism for the parent card. Transmitting the child card object may include transmitting an access mechanism for the child card. The access mechanism for the child card(s) may be nested within the access mechanism for the parent card. The method 200 then ends.

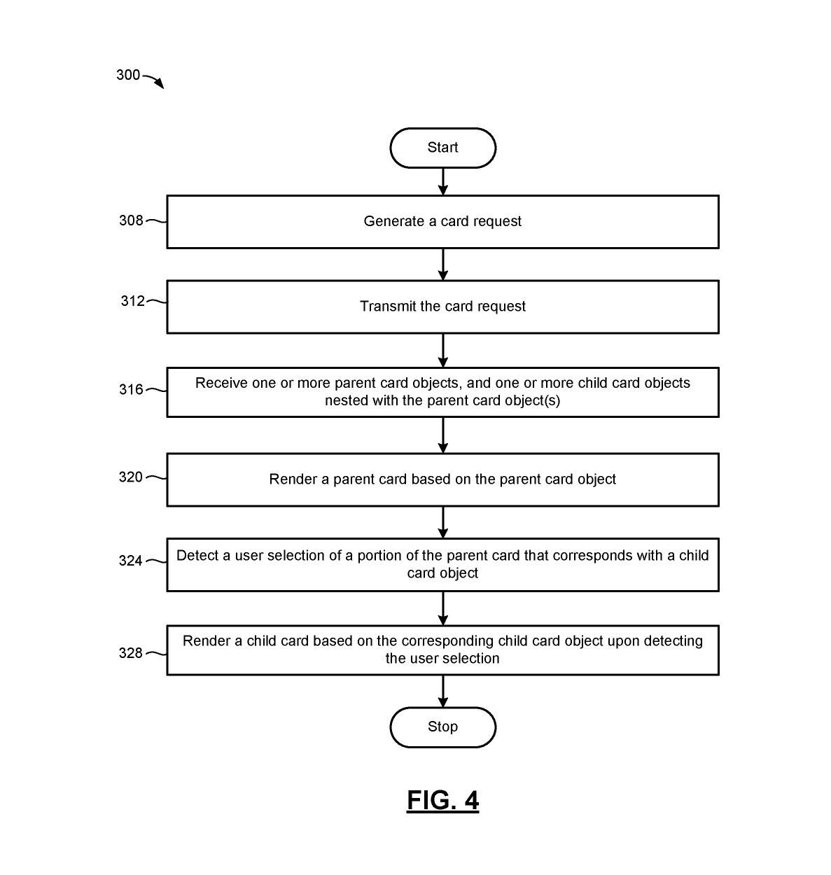

FIG. 4 illustrates an example method 300 that a mobile computing device may execute to display nested application cards. The method 300 begins at 308, where the mobile computing device generates a card request. For example, the mobile computing device generate the card request upon receiving a search query from a user of the mobile computing device. The mobile computing device may include additional information in the card request, as illustrated in FIGS. 1 and 2. The mobile computing device transmits the card request to a card server at 312.

At 316, the mobile computing device may receive one or more parent card objects and one or more child card objects upon transmitting the card request. The child card objects may be nested within their respective parent card object. The mobile computing device may utilize the parent card objects to render parent cards at 320. Certain portions of a parent card may be associated with child cards that are nested within the parent card. Upon detecting a user selected of a portion that is associated with a child card object at 324, the mobile computing device may render the child card object at 328. The method 300 then ends.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A search server comprising:
a storage device that stores a plurality of card records, wherein each of the card records includes information associated with a respective application card to be provided in response to search queries;
a network communication device that receives a card request from a mobile computing device, wherein the card request includes a search query; and
a processing device that
based on the search query, selects a first card record from the stored plurality of card records,
generates a first application card using the information included in the first card record,
identifies a second card record based on information included in the first application card, and
selectively generates a second application card using information included in the second card record,
wherein the network communication device transmits the first application card and the second application card to the mobile computing device.

2. The search server of claim 1, wherein, to select the first card record, the processing device generates a consideration set of card records based on the search query included in the card request, assigns scores to the card records in the consideration set, and selects the first card record based on the assigned scores.

3. The search server of claim 1, wherein, to identify the second card record, the processing device (i) identifies, in the information included in the first application card, a value associated with the second card record and (ii) identifies the second card record based on the identified value.

4. The search server of claim 1, wherein the information included in each of the card records includes a card record identifier, a data field indicating a display priority associated with the card record, physical dimensions associated with the card record, and information about an access mechanism associated with the card record.

5. The search server of claim 1, wherein the card request includes characteristics of a display screen of the mobile computing device.

6. The search server of claim 5, wherein the characteristics include at least one of a screen size of the display screen and a screen orientation of the display screen.

7. The search server of claim 5, wherein, to generate the second application card, the processing device (i) determines an amount of display space available based on the characteristics of the display screen, (ii) determines at least one of a display priority and physical dimensions associated with the second card record, and (iii) selectively generates the second application card based on the determined amount of display space and the determined at least one of the display priority and the physical dimensions associated with the second card record.

8. The search server of claim 5, wherein:
the characteristics include a screen size of the display screen; and
to generate the second application card, the processing device:
determines an amount of display space available for the second application card based on the screen size;
for each data field of the second card record, identifies a respective priority and a respective display size;
identifies the data field of the second card record having a highest priority value;
in response to the respective display size of the identified data field being less than the amount of display space available, adds the identified data field to the second application card; and
in response to the respective display size of the identified data field being greater than the amount of display space available, adds one of the data fields having a lower priority value to the second application card,
wherein the respective display size of the one of the data fields is less than the amount of display space available.

9. The search server of claim 1, wherein, to generate the second application card, the processing device nests the second application card within the first application card.

10. A method of operating a search system to provide application cards in response to search queries, the method comprising:
storing a plurality of card records, wherein each of the card records includes information associated with the application cards;
receiving a card request from a mobile computing device, wherein the card request includes a search query;
based on the search query, selecting a first card record from the stored plurality of card records;
generating a first application card using the information included in the first card record;
identifying a second card record based on information included in the first application card;
selectively generating a second application card using information included in the second card record; and
transmitting the first application card and the second application card to the mobile computing device.

11. The method of claim 10, wherein selecting the first card record includes generating a consideration set of card records based on the search query included in the card request, assigning scores to the card records in the consideration set, and selecting the first card record based on the assigned scores.

12. The method of claim 10, wherein identifying the second card record includes (i) identifying, in the information included in the first application card, a value associated with the second card record and (ii) identifying the second card record based on the identified value.

13. The method of claim 10, wherein the information included in each of the card records includes a card record identifier, a data field indicating a display priority associated with the card record, physical dimensions associated with the card record, and information about an access mechanism associated with the card record.

14. The method of claim 10, wherein the card request includes characteristics of a display screen of the mobile computing device.

15. The method of claim 14, wherein the characteristics include at least one of a screen size of the display screen and a screen orientation of the display screen.

16. The method of claim 14, wherein generating the second application card includes (i) determining an amount of display space available based on the characteristics of the display screen, (ii) determining at least one of a display priority and physical dimensions associated with the second card record, and (iii) selectively generating the second application card based on the determined amount of display space and the determined at least one of the display priority and the physical dimensions associated with the second card record.

17. The method of claim 15, wherein:
the characteristics include a screen size of the display screen; and
generating the second application card includes:
determining an amount of display space available for the second application card based on the screen size;
for each data field of the second card record, identifying a respective priority and a respective display size;
identifying the data field of the second card record having a highest priority value;
in response to the respective display size of the identified data field being less than the amount of display space available, adding the identified data field to the second application card; and
in response to the respective display size of the identified data field being greater than the amount of display space available, adding one of the data fields having a lower priority value to the second application card,
wherein the respective display size of the one of the data fields is less than the amount of display space available.

18. The method of claim 10, wherein generating the second application card includes nesting the second application card within the first application card.

19. A non-transitory computer-readable medium storing instructions for execution on processing hardware, the instructions comprising:
storing, at a storage device, a card data store that stores card records, wherein each card record includes:
a card record identifier (ID);
one or more data fields, wherein each data field being associated with a display priority and a physical dimension; and
an access mechanism template;
receiving, via a network communication device, a card request from a mobile computing device, wherein the card request includes:
a search query with one or more search terms; and
a screen size of the mobile computing device and/or a screen orientation of the mobile computing device;
generating a consideration set of card records based on the search terms in the query;
scoring the card records in the consideration set;
selecting one or more card records from the consideration set based on the scores of the card records;
generating a parent card object for each of the selected card records;
for each parent card object, identifying at least one value in one of the data fields that is associated with another card record;
generating a child card object based on the other card record;
determining an amount of display space that is available for rendering a child application card;
writing data fields from the other card record into the child card object based on:
the display priorities associated with the data fields; and
a comparison of the physical dimensions of the data fields with the screen size, and/or screen orientation; and
transmitting, via the network communication device, the parent card object and the child card object to the mobile computing device.

20. The computer-readable medium of claim 19, wherein:
the card request includes a screen size of the display screen of the mobile computing device; and
generating the child card object includes:
determining an amount of display space available for the child card object based on the screen size;
for each of the data fields of the other card record, identifying a respective priority and a respective display size;
identifying the data field of the other card record having a highest priority value;
in response to the respective display size of the identified data field being less than the amount of display space available, adding the identified data field to the child card object; and
in response to the respective display size of the identified data field being greater than the amount of display space available, adding one of the data fields having a lower priority value to the child card object,
wherein the respective display size of the one of the data fields is less than the amount of display space available.
